(19) United States
(12) Patent Application Publication
(10) Pub. No.: US 2008/0065534 A1
(43) Pub. Date: Mar. 13, 2008

(54) Charging/Reward-Payment System Used In Internet

(76) Inventor: Kazuo Ooyama, Tokyo (JP)

Correspondence Address: KIRK HAHN, 14431 HOLT AVE, SANTA ANA, CA, 92705, US

(21) Appl. No.: 11/572,108

(22) PCT Filed: Mar. 23, 2005
(86) PCT No.: PCT/JP05/06008

§ 371 Date: Jan. 14, 2007

(30) Foreign Application Priority Data
Jul. 13, 2004 (JP) 2004-232816
Oct. 25, 2004 (JP) 2004-336631

(51) Int. Cl. G06Q 30/00; H04L 9/32

(52) U.S. Cl. 705/40

(57) ABSTRACT

Disclosed is a novel charge assessing system solely operable via an internet service line, which is characterized by novel functions including the following: Initially, a server for running a web site owned by a distribution operator stores a numeric value of a variable x in correlation with ID of individual users, which is constantly shown on a display screen of a terminal owned by a corresponding user. Whenever the user pays a charge, actual value of the variable x is increased in proportion to the paid amount. When the above server automatically transmits information in response to a command from the user's terminal, actual value of the variable x is decreased by a numeric value corresponding to a stored consideration correlated with said information. If the actual value of the variable x were below the numeric value of the consideration, the server rejects provision of newer information. A novel discount system is further disclosed, which functions for the re-provision of information operable for the charge assessing system in the information providing service workable via an internet service line. A novel remuneration paying system concurrently with a charge assessing system pays a remuneration to any of information providers who have actually provided various information. Availing of the charge assessing system for the information providing service via an internet service line, the novel remuneration paying system pays a remuneration to plural authors of secondary productions in conjunction with a system for arranging the copyrights of the original author against authors of secondary productions.

### FIELD OF THE INVENTION

The present invention relates to a billing system for a information distribution service in an automatic public transmission, such as, the Internet. In particular, the invention relates to a system that can control access, a discount system for distributing the same information to the same user, and a payment system for a user who offers information (hereinafter information provider).

### BACKGROUND ART

It is well known that sales of goods has widely spread over the Internet, not only tangible products, such as, publications and CD sales; but also intangible products, such as, music distribution and image content. Also, electronic files, such as, documentation, data files, movie files, and program files can be sent in an automatic public transmission at the request of the user's terminal. There is a billing system for sales of information as disclosed in laid-open Japanese Patent Publication No. 2003-303289.

All the websites open to the Internet have some information. Accessing these websites, and showing it on your screen means that the website server automatically transmitted information to your computer. Some websites contain images and movies you can view and enjoy in addition to character information. Similary, some websites contain an accounting table system where a user can access and use it, or websites that a user is able to obtain useful news or a list of numerical values for a charge. Information service of not selling information data and not leaving them to user's computer but allowing a user to view it for some charge is disclosed in laid-open Japanese Patent Publication No. 2003-178239.

In this way, we call showing information on the websites by an automatic public transmission without sales of information “information browsing service”. Additionally, we call showing information on the website by an automatic public transmission with sales of information, such as, data “information distribution service”, and we call those who provide these service “information distributor”.

The payment method used in the information distribution service by the Internet is to use a credit card, webmoney, or bit cash on an electronic pre-paid card. Furthermore, there is notion of having pre-paid account for the Internet other than banks as disclosed in laid-open Japanese Patent Publication HEI 9-114904. We call these conventional technologies A.

Furthermore, there is a notion of making an user's device embedded with special equipment as disclosed in laid-open Japanese Patent Publication 2003-60814 and 2002-109425. We call these conventional technologies B.

Furthermore, the delivery of specific news and information by email for a subscription fee for a certain period of time allows unlimited access to the website for information during the subscription period. These can be paid by not only a credit card payment, but also cash, a bank remittance or many other methods. We call these conventional technologies C.

It is a known technology on which this invention is based to send an user's ID and password to a server, an user can view stored information on a server associated with said user on the screen of said user's terminal, and to store user ID and password on user's computer with which an user requests a server to authorize each user.

However the conventional technology A used in the Internet, such as, a credit card payment; requires the payment of a commission to the credit card company who collects the money from the card user. As a result, there is a drawback that a credit card is only used when there is a reasonable amount of money. The credit card payment requires a user to enter the card number and user's name for each transaction. An electronic prepaid card still requires a user to enter a card number and the card must be retained. Even with the card in hand, the operation is complicated and difficult for a juvenile to use. Using a credit card to pay for an automatic information transmission for a small charge, such as, a few 10-yens is not suitable for a transaction that still requires handling and possible divulgation of a credit card number. Also the action to pay operation 1 cannot complete the request and payment of automatic information transmission due to the necessity of the action to pay.

In the billing system of conventional technology B with an user's device embedded with special equipment; the user has to pay for the equipment, or the drawback that an user might hack into the device and damage the credibility of the entire system. In the conventional technology B, an user can check with an appropriate action the account the user has paid in advance. However, the user cannot get charged an information provider service while simultaneously checking the rest of the account in real time. Plus, there is no way to purchase information while confirming how much it is left from the previous time, how much has been spent at this time, or how much was used today.

In the subscription method of conventional technology C, the cost is low for collecting charges per total amount of information available, and information is available to a certain extent during subscription period and easy to access. However, this method has the problem that it does not allow the purchase of information piece by piece, and users have to pay in advance for all the information the subscription encloses even when users want just a piece of information for information distributor. Additionally, it has the problem that multiple users can access and get information with one user ID because there is no way to identify multiple user access. It is a general rule that users will be asked to pay again when users want to get the same information for some reason. Therefore users tend to think they want to store data or print it out as paper. Therefore users tend to think they want to possess information and store it at each user's terminal. There is a lot of duplicated data in a whole society, and it is waste of social resources in consideration of organizing and facilitating these data. For those who provide information, hereinafter, information providers, conventional remuneration payment system to information they provide does not allow them to grasp the sales status and quantity directly, and reward is usually paid after a considerable period has passed since the actual sales date. Those payments cannot be used directly when to purchase information from the other.

The payment to individuals who provide the information to the information distributor by the Internet is often in proportion to the number of sales, but the actual sales status is not known unless the distribution records are disclosed. However those records are not usually disclosed to an information provider. So an information provider has to believe the sales number on the report from information distributor. Furthermore, an information provider wants to get paid for copyrighted work as soon as possible, and wants to know in real time when their information was sold and what kind of user purchased it. As long as an information distributor does not organize the information of interest and report it to them, an information provider cannot get any feedback other than by the payment of rewards on monthly basis at most. The payment of rewards to an information provider by an information distributor usually will be delayed several months because it will be paid in a lump sum after a summary of the received money. It takes a lot of time for information providers to get an actual reward after the actual sale of their information, and the rewards must be cashed to make use of the information distribution service because the remuneration system is not integrated with the billing system.

Some people may want to set a poem to music when they read it and eventually make a song. A novel might be turned into a comic, short story might be turned into novel, or a Japanese novel might be translated into English. Also Japanese technical information and workshop material might be translated for foreign people. These secondary copyrighted works have the same right of copyright as the original copyrighted work. However, the original copyrighters still possess the right to these secondary copyrighted works. The coordination of these copyrights is held by the publishers or companies which own the rights in the case of a document, and the record companies in the case of a poem and music.

People sometime act from impulse and want to set a poem to music without being asked, or translate foreign material into Japanese due to their motivation to know the content. For example, if you want to create a picture book based on a story, you have to contact the original copyright owner through the publishing company, and ask another publishing company to publish the picture book. Therefore, the coordination of copyrights is a very complicated task even in the domestic case, so it rarely happens to disclose secondary copyrights. It is even more complicated in a case with a foreign original copyright owner. There are a lot of songs that were made but not distributed, or translated scripts made but not published, so they remain unused by the whole society.

The present invention solves the problems as described above. It is an object of this invention to solve the first problem by implementing an easy-to-use billing system which makes the cost of the collected commission low in ratio to the purchase. Thus, this keeps the collected commission low even when a user wants to enjoy an information distribution service which charges a small cost per information item, one at a time, without using special equipment on an user's terminal or forcing an user to enter a password every time with the existing facilities. This allows an user to purchase automatic information transmission by user's one instruction get continuously an information distribution service.

It is another object of this invention to solve the second problem by reducing an user's financial expense when the user wants to retrieve the same information. At the same time from the point of information distributor's view, this prevents multiple users from accessing the server with the same user ID.

It is another object of this invention to solve the third problem by paying a reward the moment the information is sold in a certain ratio of the amount of sales to information providers to remove dissatisfaction or frustration by the information providers. Information providers can get feedback the moment a user purchases their information and know at any the time the change of feedback by looking at the records of reward generating transactions. Furthermore, these data are stored in the server of the information distributor; so information providers can determine the purchasing class by organizing and analyzing the data themselves without invading privacy.

Furthermore, rewards can be used for getting other information without first cashing the reward points. As described above, it is another object of this invention to facilitate the offering of more useful information by enhancing the convenience of information providers.

It is another object of this invention to solve the fourth problem by implementing a remuneration payment system which enables prompt coordination between the right of original and secondary copyrighted work. It is another object of this invention to facilitate the publication and circulation of secondary copyrighted work, which is rarely published. Also, it will improve the motivation of people to produce secondary copyrighted work, which can contribute the development of culture and economy of humankind. Disclosure of the Invention The first means for solving problems for achieving the above object of the present invention essentially comprises a step of causing individual user terminals to transmit user's ID and passwords to a specific server so as to cause a variable x correlated with the corresponding user's ID stored in said server to be displayed on the terminal of the corresponding user; a step of causing said variable x corresponding to a paid amount to be increased (or decreased) in response to the payment of charge by the corresponding user; a step of causing said variable x to be increased (or decreased) by a numeric value corresponding to the above paid amount stored in said server correlated with said information whenever instructions are given for automatic transmission of information from said server in response to the one instruction by the terminal of the corresponding user; and a step of disabling provision of any service for automatic transmission of new information in the event if said variable x becomes lower than (or higher than) a predetermined numeric value after provision of a requested information.

Note that the above descriptions shown in parentheses supplement the above-cited terms correlated with variables expressed as “increased, higher than, lower than, subtracted” can become equivalent to the substitutive terms expressed as “decreased, lower than, higher than, added”. These supplementary terms will be deleted in the following description.

Functional procedure of the first means for solving problems is described below. First, the present invention adopts the problem solving means by paying a collected sum approximating to ¥1000 to a distribution operator en bloc. By virtue of this payment, the inventive means dispenses with the input of any of card numbers and user's name by referring to a user's card whenever any user makes use of an information providing service, thereby making it possible to minimize potential risk of externally leaking user's card number, and yet, enabling the user to save the service charge by decreasing the frequency of the payment via the card.

After causing a variable x correlated with the ID of a corresponding user stored in the server of a distribution operator to be displayed on the terminal of this user, when the user pays a service charge, the numeric value of this variable x is increased relatively to the paid charge amount. Concretely, when the user pays ¥1000 via the card for example, the numeric value of the variable x is increased by 1000 points. Since the increased value of the variable x via the payment coincides with the actually paid amount, the above method provides a convenient availability for users.

When a user makes an advance payment, it simultaneously benefits a distribution operator in that receivable money is determined at the same time. Payment can be made via every practical method including a credit card, an electronic prepaid card, cash payment at a store, or via a budget account, or the like. Considering that expenses for money collection vary depending on any of the available methods, the distribution operators will be able to guide users by way of setting incremental points for users according to the payment method so as to enable them to optionally choose an inexpensive payment method.

In order to collect users, it is also allowable for any distribution operator to grant service points at the time of allowing entry of any user or on user's own charge account for a predetermined point amount. For example, it is practicable for any distribution operator to grant provision of 300 points for a newly entered user or allow him to use his card until the variable x reaches 300 points, or allow any promising user, such as, a person who has registered a card and secure payment, to enable him to use his own card on his charge account until the variable x reaches 100,000 points, for example. It is also allowable for any user to establish his own maximum limit of available numeric value within a scope authorized by a corresponding site controller.

Even when a distribution operator itself is concurrently with a line supplier or a provider for internet services, it is conceivable that there are many cases of adopting a charge account based on a fact that information providing charge including a line servicing charge and the provider contract charge collectable per month has actually been charged on users. When there is any specific contract with a user to settle a charge account every predetermined period via a card registration or via a direct charge to the user's bank account, no payment is made in the intermediate period of every month, and thus, when availing of information providing services, display of the sum of service charges using positive numeric values goes with user's sense.

In the light of the above practical cases, as described earlier, those terms “increased, higher than, lower than, subtracted” may have been substituted by those terms expressed as “decreased, lower than, higher than, added”, respectively.

As described above, such a conventional practice is well known, in which, once a user has input his own ID and password, and stored both in his terminal, he can practically eliminate from now on the troublesome input of his ID and password. After storing own his ID and password in his terminal, the user will be able to display a variable x correlated with own ID by a less operating procedure, thereby enabling him from now on to make use of an information providing service. Once a protector has completed the essential setting, he will be able to make use of information providing services, and yet, even an infant or child will be able to make use of an information providing service by displaying a numeric value x correlated with his own ID on a terminal.

Next, a practical method of utilizing an information providing service is described below. After displaying a variable x correlated with own ID on his terminal, it is no longer necessary for any user to input own ID and password for displaying a payment screen whenever receiving information and also for taking steps for effecting a payment, but it is possible for him to make use of an information providing service via single operation by way of successively clicking characters set via a banner, an icon, or a link connected with a desired information from a home-page displayed on his terminal via a mouse, for example. It is possible for any user to read the displayed information with a normal sense of reading and a speed similar to the case of reading an optional page shown in a conventional free site. Whenever a user makes use of an information providing service, a charging process is executed by way of decreasing a variable x correlated with a user's ID stored in a server by a number corresponding to its consideration. This represents that any user makes use of an information providing service in the course of serially settling prepaid accounts or charge accounts against a corresponding distribution operator.

On the other hand, since a charging process can be easily implemented, it in turn might make an user to feel anxiety about an excessive use of a provider services. Any user will be able to read an optional page while constantly confirming the number of remaining points by checking the variable x constantly shown on a display screen. In the event the variable x becomes lower than a numeric value predetermined by a user or a site controller, automatic transmission of any new information is disabled, and thus, there is no fear of overlooking the low value of variable x. The novel charging system according to the present invention is so easy to handle that it enables normal protectors and even infants or children to properly operate it. In this sense, the inventive charging system is particularly suitable for providing learning materials for infants or children. The easily operable system provides many advantages for all users without restricting the object solely to infants and children. The inventive charging system further provides a great advantage in that it does not need any specific apparatus, but can be used with any conventional computer terminal, an optional internet service line, and a site server.

Further, by enabling a server to store an initial value x0 of the presently accessed variable x correlated with IDs of individual users stored in the server, a numeric value is generated by the increased variable x caused by the payment made at the time of the present access, and a total numeric value b remaining after subtraction from the variable x via the utilization of an information providing service at the presently accessed time, it is also possible to display more than one of the variables x0, a and b on the user's terminal simultaneously with the display of the above-referred variable x.

In terms of the functional aspect, any user will be able to receive desired information whenever required by way of instantly confirming the actually displayed numeric value of points x owned by himself in conjunction with the initial value x0 of the variable x at the presently accessed time, a numeric value comprising the increased variable x generated by an advance payment effected for now, and some of the numeric value b applied for now, thereby making it possible for him to make use of an information providing service while taking enough care not to excessively consume own points and confirming that the current account is clear.

The second means for solving problems comprises the following; an initial step for enabling a server to store a user's ID, a data number, and the transmission effected time as a record of information provided for this user, an ensuing step for retaining the stored record for a predetermined period of time under a predetermined condition, an ensuing step, in which an information subject to automatic transmission as per instructions from a terminal of this user is referred to the stored record, and then, when the user's ID coincides with the data number, it is identified that an identical user has requested re-transmission of an identical information, and a final step for lowering the number for subtracting the variable x from a numeric value representing a case in which an initial request was generated.

To implement the second inventive means, it is proposed that two discount systems may be provided. The first discount system comprises an initial processing step of causing the value of variable x stored in a server correlated with a corresponding user to be decreased by a specific number correlated with an operation for automatic transmission of information as per instructions from a user's terminal whenever the user makes use of a service for provision of new information, an ensuing step for referring the decreased value of variable x to the past record, and an ensuing step for causing the numeric value of the variable x to be increased by a predetermined number only in the case in which the decreased value of variable x coincides with the past record. The second discount system comprises an initial step for causing a numeric value remaining after subtraction from the value of variable x to be referred to the past record whenever a corresponding user actuates an operation for automatic transmission of new information, and an ensuing step for lowering the above numeric value only when said numeric value coincides with the past record. Since the first discount system initiates transmission of new information to a corresponding user prior to the reference to the past record, the fist discount system advantageously enables the user to read desired information earlier than that can be done via the second discount system. On the other hand, the first discount system prohibits the user from making a purchasing operation unless the numeric value of the variable x built in an exclusive home page remains by a value above the number of points required for making an initial purchasing operation. Conversely, the second discount system has the advantage of enabling the corresponding user to make a purchasing operation when the numeric value of the variable x built in an exclusive home page remains by a value exceeding the discount points.

Next, functional operation of the second means for solving problems is described below. Any user may desire to review such information previously read via a provider service. In this case, or in the case in which a purchased item becomes unusable for any reason, or in the case in which the user can not find the exact location of the stored information, an user may want to receive another copy of the identical information. The discount system according to the present invention lowers the monetary burden on the part of users when any of the above incidents actually occurs. Assuming that when a user actuates instructions for automatic retransmission of any information previously acquired from an information providing service via an identical computer in the past, if the user merely incurs a slight burden, the user will not feel it necessary to store all the data via copying or output all the data as paper documents subject to filing. If this occurs, it will result in a decreased load on the data storage capacity on the part of a computer owned by a corresponding user, as well as, minimize the labor needed for arranging information on the part of the user, and yet, it will also lessen the burden incurred to the user himself and further lower load incurring to all the social entities.

Anyone will think that a free service may be shared with friends. On the other hand, if an available service more or less requires a consideration, anyone will feel a hesitation to have his friends make use of the pay service. From the standpoint of any distribution operator, such an effect for preventing multiple users from misusing the information providing service can be expected, and yet, even if multiple users jointly committed a misuse, it is possible to collect some amount of charge from them, and thus, the second means constitutes a system allowing its useful utilization in a family for example.

The third means for solving the problems constitutes a charging system concurrently with a paying system through which any user can become an information provider. Basically, any information provider specifies a certain amount of consideration. However, any information provider can optionally choose a consideration from some candidates proposed by a corresponding distribution operator. After receiving the required information, a server of a corresponding distribution operator stores information received from an information provider as of the condition automatically transmissible via a public telecommunication service line and simultaneously stores ID of this information provider by correlating with an automatic transmission instruction operator against the received information, a numeric value corresponding to the consideration for provision of the above information, and a remuneration rate P against a predetermined consideration for the provision of said information. When a user's terminal outputs instructions for automatic transmission of said information, the server automatically transmits said information and simultaneously causes a numeric value of variable x stored in the server in correlation with the ID of the above information provider to be increased in accordance with a numeric value resulted from multiplication of a consideration for the information providing service by the remuneration rate P.

In terms of the functional aspect, any information provider can determine a consideration for provision of information based on his own intent. Since it is possible to provide information free of charge, any information provider can freely set the consideration rate, for example, by publicizing information free of charge while he still remains unknown and then provides information on the fee basis when his popularity has grown, or by publicizing a novel free of charge for the former half and charging a fee for the latter half thereof. Since the price can be determined depending on the popularity, content of the novel, or the intent of the information provider, it is possible for the information provider to pursue a maximum profit or conversely set a consideration that is inexpensive in anticipation of publicity by the potential growth of readers.

Any information provider represents individual authors who have provided a distribution operator with a variety of materials including photographic images, illustrations, novels, short poems, haiku, music, comics, video for classes, educational materials, and other useful information. Any information provider can optionally determine a consideration for the information providing service. When a conventional user makes use of the information providing service, the information provider simultaneously acquires a certain number of points corresponding to the remuneration for the provision of information. Since the information providing condition is correlated with the user data stored in a site server, the present system enables the information provider to serially grasp distribution and activities of individual users requesting transmission of information with a method that does not infringe personal privacy. Further, it is also possible for the information provider to have the analyzed condition of use reflect upon the following work and detect the direction for provision of the following information. The above system processed via a computer can hardly be changed to facilitate monitoring of a variety of tax-levying opportunities, and thus, reliability is highly regarded on the above remuneration paying system automatically processed via a computer. By merely referring to a fact that points are serially added up, the information provider is able to determine an increase in purchasers. By further analyzing the additional pace, it is also possible to confirm that there is no fear of changing the current system after halfway, thereby enabling the information provider to trust the distribution operator.

When there is a request for re-provision of information, consideration for the provision of information may vary according to the discount system. However, even in this case, a remuneration is payable against the varied consideration based on a predetermined rate.

The above system for paying a remuneration based on the counted points hypothetically executes a payment for the remuneration, and thus, by converting the above-cited variable x into cash, any of the information providers can actually receive a remuneration for the provision of various information including the royalty, or the like.

Since a remuneration for the provision of information, such as, a book or a production is payable against the provision of information receivable via a small amount of consideration, only a small amount of remuneration is paid to an information provider for the provision of information per round. If the provider serially settles remuneration accounts via own budget account, it will cost higher than the individual remunerations. Hence, availing of the variable x applied to the charging system stored in a server in the form correlated with the ID of a user who actually provided information, the present system hypothetically pays a remuneration via an arithmetic operation executed by the server, thus advantageously realizing the payment of a remuneration at a low cost.

Any user who has actually provided useful information, including books/productions subject to distribution via an internet service line is entitled to make use of an information providing service by applying own variable x added up as a remuneration for providing said information and also enabled to receive a remuneration for the royalty in cash by optionally converting the variable x into cashing. As an information provider, any user is advantageously enabled to minimize a time-lag for receiving a remuneration in cash from the time of providing the above information and also enabled to freely adjust the time of cashing. Further, unlike the provision of information in the form of publications or compact discs, presentation of electronic information via an internet service line by applying a remuneration paying system embodied by the present invention can be publicized by the information provider himself, thus minimizing personnel cost required for collecting, publicizing, and providing information. Further, since a total process from monetary collection to the payment of remuneration has been automated, no manpower is required for the tallying operation to result in the minimized cost, thereby taking advantage of establishing the remuneration rate for the royalty payable to a specific information provider at a higher level. Taking the case of book publication, for example, it is possible for the present system to set the royalty up to about 50% against about 10% of the conventional royalty. The minimum expenses required for provision of information in turn signifies that it is possible for the present system to deliver such information so far having the least demand without being transmitted to a conventional distribution route of any information providing service line, thus making it possible to potentially increase the volume of information in the society.

The fourth means for solving the problems comprises a charging system concurrently with a remuneration paying system accompanied with a system for strictly adjusting the copyrights available for publicizing the secondary productions. In many cases, information provided by an information provider comprises a book or a production. In order to publicize any of the secondary productions realized by way of any transformation or translation, it essentially requires a strict adjustment between individual authors and the publishing rights. Availing of an internet service, the present invention aims at smoothly facilitating adjustment of the publishing rights.

It is required that any of the secondary authors contact the original author and secure an approval prior to the eventual publication of the correlated secondary production. However, information about the original author should not be disclosed carelessly because there are many people that have a malicious intent against public figures. Hence, the present invention arranges a system to enable the original author to contact the publishing party only in the case of contributing a secondary production to the publishing party because he can easily identify whether the secondary author has a benevolent or malevolent intent by closely reviewing the contents of the secondary production intended for publication.

Next, a procedure for implementing the fourth means is concretely described below. Initially, upon completion of a production, the secondary author transmits the completed production with a letter of self introduction to a server of a distribution operator in the form of contribution. At the same time, the secondary author enters a proposal on the consideration as of the information provided time and the share division rate for the remuneration between the original author and himself. Upon reception of the secondary production, the server of the distribution operator stores the secondary production in the state automatically transmissible solely to the original author and simultaneously informs the original author of the contribution made by the secondary author. At the same time, the server informs the original author of the mail address of the secondary author via an attached message. Upon reception of this information, the original author confirms the corresponding secondary production, the letter of self introduction, and the proposed share division rate for the remuneration. These constitute an introductory message from the secondary author to the original author. Upon confirmation of the received secondary production, the original author transmits a commentary message on the points requiring improvements and correction against the proposed share division rate of the royalty by replying to the correspondence address of the secondary author accompanying the above message informing the secondary author of the contribution if the original author disapproves the proposed contents. When the original author approves publication of the secondary production, he clicks a publication approving button on the display screen of his terminal, and consequently, the above secondary production enters into a state enabling automatic transmission of the secondary production to the public users before actually being publicized.

When dealing with such information provided by plural users as the one represented by secondary productions, the server stores ID of plural users who have provided information correlated with instructions for automatic transmission of information and also stores predetermined individual remuneration rates Pi applicable to the consideration for the provision of the corresponding information payable to individual information providing users, and then, by causing a numeric value of variable xi stored in the server in correlation with the user's ID to be increased in accordance with a numeric value resulted from a multiplication of the consideration for the provision of information at the present time by the remuneration rate Pi, the resultant remuneration is paid to individual information providers.

The third and fourth means for solving the problems have respectively been provided in order to have them function as a charging system concurrently with a practical system for paying a remuneration to information providers. However, when rashly applying such a system for paying a remuneration using a variable x identical to the one applied to the charging system, the remuneration paying system remains unguarded to anyone having a malicious intent. Typically, this is exemplified by a case in which, immediately after making a payment with a large amount of money via a shortly expiring card or a stolen card, the bearer of this card could illegally liquidate the sum into cash or by a case in which anyone who received points from the bearer of a stolen card could also liquidate the sum into cash. There is a further potential risk in which, availing of a time lag for settling card accounts for about two months, anyone having a malicious intent could attempt to gain a profit accrued from interest immediately after making a payment with a large amount of money. Taking these potential risks into account, the inventive system enables individual servers to separately store the sum of the remunerations payable to users for the result of providing information, and then, if any user instructs a liquidation of an amount exceeding the sum of the remunerations stored in the servers into cash, the inventive system disables the liquidation procedure.

As described above, according to the first means for solving problems, by enabling any user to previously store own ID and passwords in his terminal, it is no longer necessary for the user to input own ID and passwords so as to access a variable x correlated with own ID, and then, by making an advance payment or a purchase on credit as conventionally practiced, the user is enabled to quickly and successively receive required information by merely operating a button for the information providing service on a home page. Hence, the present invention provides a novel charging system that enables any user to easily and securely apply thereto by referring to the preset maximum limit allowed for use.

According to the second means of the present invention, it is possible to lower monetary burden on the part of user whenever he desires to receive the once-provided information again. At the same time, from the standpoint of any distribution operator, there is an expectation on the practical prevention of plural users from committing multiple use of the remuneration paying system.

According to the third means of the present invention, it is possible for individual information providers to optionally determine a consideration for the information providing service and further grasp the actual condition of use on the part of users on the real-time basis. When applying the third means as a system for paying a remuneration for the provision of information represented by the royalty for example, reliability is enhanced.

According to the fourth means of the present invention, it is possible to publicize a secondary production simultaneously with completion of an adjustment of the copyrights between an original author and a secondary author and enable the finalized share of remuneration to reflect upon the paying system. Hence, publication of the original production leads to an act of collecting secondary productions. This in turn promotes further creation of secondary productions so as to contribute to the development of rich cultures, and further promotes circulation of secondary productions and eventual growth of economy.

### BRIEF DESCRIPTION OF THE DRAWINGS

In the accompanying drawings;

FIG. 1 is a schematic diagram of the information providing system according to an embodiment of the present invention;

FIG. 2 is a flowchart of the charging system according to the first embodiment of the present invention;

FIG. 3 is a display view on a user's terminal screen according to an embodiment of the present invention;

FIG. 4 is an enlarged view of the portion Z shown in FIG. 2;

FIG. 5 is a display view of a home page for marketing data information according to the present invention;

FIG. 6 is a display view of a home page for providing an information reading service according to the present invention;

FIG. 7 is a flowchart of the charging system when rendering a service for providing information via the first discount system according to the second embodiment of the present invention;

FIG. 8 is a flowchart of the charging system when rendering a service for providing information via the second discount system according to the second embodiment of the present invention;

FIG. 9 is a flowchart of the remuneration paying system for those who have provided information according to the third embodiment of the present invention;

FIG. 10 is a flowchart ranging from the time at which a secondary author has contributed a secondary production up to the time at which said second production becomes automatically transmissible to conventional users via a public telecommunication service line;

FIG. 11 is a flowchart of the remuneration paying system for dealing with plural information providers according to the fourth embodiment of the present invention; and

FIG. 12 is a flowchart of the liquidation process applied to the third and fourth embodiments of the present invention for implementing the payment of remuneration.

### EXPLANATION OF THE REFERENCE NUMERALS

1: User's terminal
2: Internet service line
3: Web-site server
21: The first portion of display screen of a user's terminal
22: The second portion of display screen (information reading part) of a user's terminal
23: The third portion of display screen of a user's terminal
24: The fourth portion of display screen of a user's terminal
25: The fifth portion of display screen of a user's terminal
   (explanation of provided information and display of button for instructing automatic transmission of information)
31: Banner
32: Banner
33: Button for returning to the preceding page
34: Reading suspending button
35: Automatic transmission instructing button
41: Icon
50: Display of price when a user reads one of serial pages under review
51: Display of a numeric value x0
52: Display of a numeric value a
53: Display of a numeric value b
55: Display of a numeric value x
61: Audition button
62: Music distribution button
63: Music data purchasing button

### OPTIMUM FORM FOR EMBODYING THE INVENTION

In order to more accurately describe the present invention, referring now to the accompanying drawings, essentials of the present invention are described hereinafter.

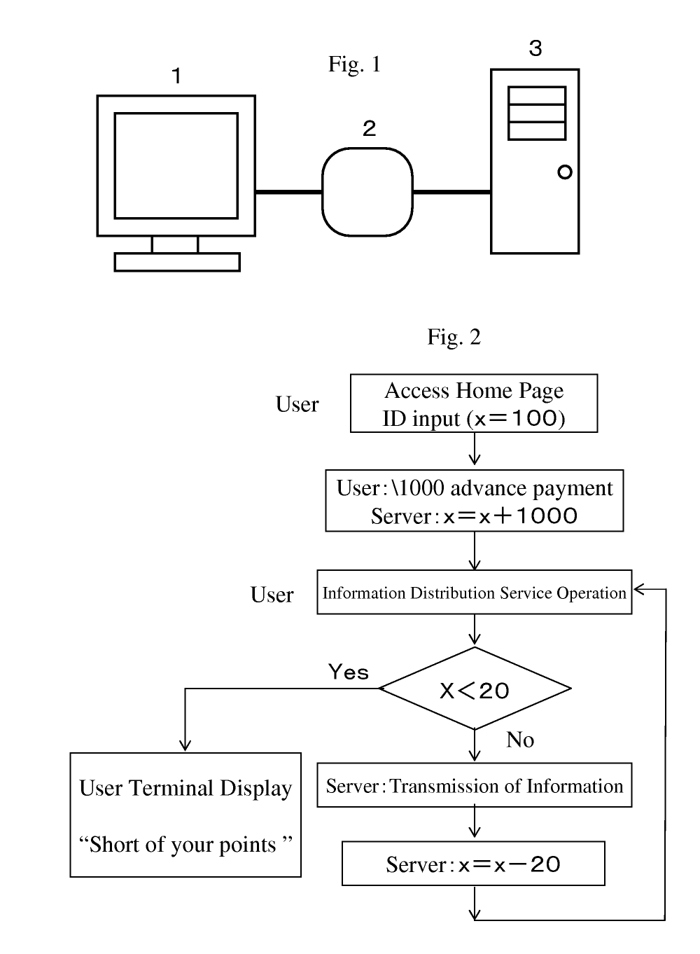

FIG. 1 is a schematic diagram of the information providing system according to the first embodiment of the present invention. Reference numeral 1 designates a computer terminal owned by a user. Reference numeral 2 designates an internet service line. Reference numeral 3 designates a site-server owned by a distribution operator.

FIG. 2 designates a flowchart of serial operations executed by the above information providing system. It is so arranged that, by causing terminals of individual users to transmit their own IDs and passwords, a variable x correlated with the ID of a corresponding user stored in the site server 3 is transmitted to his terminal and displayed on the screen thereof. In the present case, a numeric value 100 is displayed on the screen of a terminal owned by a corresponding user, where the terminal is designated by a variable x having a numeric value 100 at the accessing time. When the corresponding user makes a payment, the numeric value increases in accordance with the paid amount. The present embodiment adopts an advance payment. When the above user paid ¥1000 in advance, it indicates that the above variable x has been increased by 1000. The user is aware that the actual numeric value corresponds to the points own by himself. When the user utilizes an information providing service corresponding to the points 20, due to adoption of the advance payment, since he cannot use the above service until the points is reduced to a negative value, if the number of point were less than 20 being the numeric value of a consideration for the information providing service requested by him, the terminal screen displays a message advising him that “the actual number of your points is short”, and thus, he cannot receive automatic transmission of required information. Conversely, if the actual number of point exceeds 20, required information is automatically transmitted to his terminal to cause the variable x to be subtracted by 20. According to the above serial processes, the above user is enabled to successively make use of an information providing service via an operation and a speed as in the case of acquiring required information via a review on a conventional home page shown free of charge.

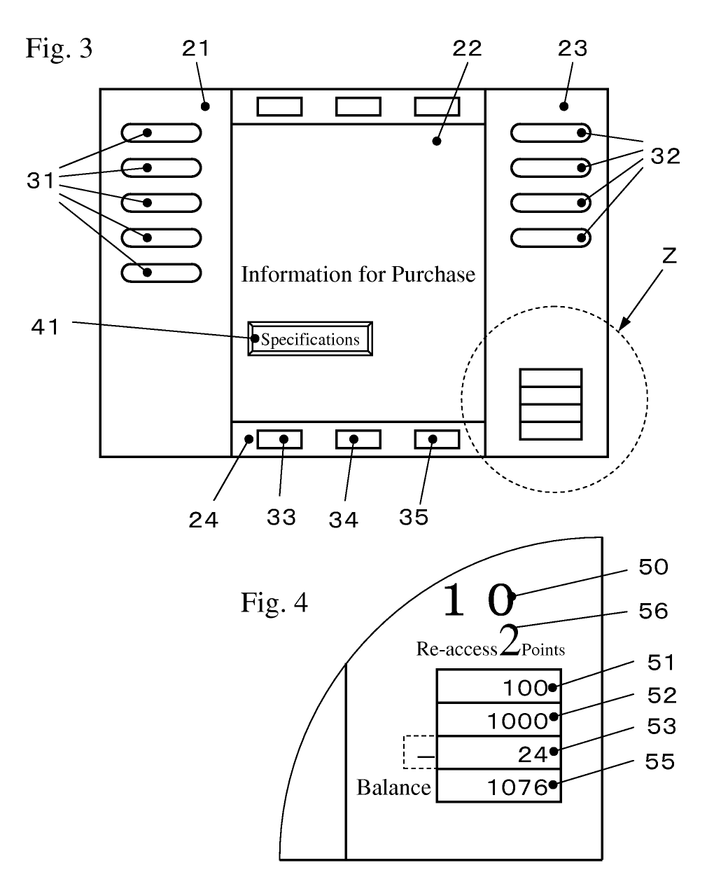

FIG. 3 designates a state of display on a terminal screen owned by a user practically making use of the information providing service according to the second embodiment of the present invention. The terminal screen of this user dividedly displays the first portion 21 displaying a banner 31 linked with another web-site, the second portion 22 for enabling the user to read the information received via automatic transmission, the third portion 23 displaying a banner 32 linked with other serial pages within the web-site, and the fourth portion 24 including an automatic transmission instructing button 35 for enabling the user to read a new page via clicking, a returning button 33 for returning to the preceding page, and an information reading suspending button 34. An icon 41 is displayed on the second portion 22, which is linked with a page describing further details of information shown on the second portion 22.

FIG. 4 is an enlarged view of the portion Z shown in FIG. 3. A value of consideration expressed as 10 and a numeric value 50 are respectively shown on one of serial pages under review with a magnified scale. The numeral 10 indicates that a numeric value 10 is subtracted from the presently existing variable x per reading of the information shown on a page. The inventive information providing system comprises a display unit 55 for displaying a numeric value of the variable x designating the actual points owned by a user, another display unit 51 for displaying the initial value x0 of the variable x at the presently accessing time, another display unit 52 for displaying a numeric value comprising a value added to the variable x as a result of an advance payment made for now, and another display unit 53 for displaying a numeric value b comprising a sum of numeric values remaining after subtracting the variable x as a result of the use of the information providing service for now. Any user is enabled to make use of the information providing service while visually confirming the actual numeric values shown on the display screen.

Transition of the above numeric values is concretely described below. At the preceding accessing time, a private home page owned by a user had a value 100 of the variable x, which was displayed on the display units 51 and 55 at the accessing time. The remaining display units respectively display no value 0. When the above user paid ¥1000 in advance as a charge, a numeric value 1000 is displayed on the display unit 52, whereas the numeric value shown on the display unit 55 is increased to 1100. Next, when the user reads information shown on a pay page, a numeric value 10 is displayed on the display unit 53, whereas a numeric value 1090 is shown on the display unit 55 via a subtraction by 10. When the user reads information shown on 12 pay pages, a numeric value 120 is shown on the display unit 53, whereas the numeric value of the display unit 55 becomes 980 via a subtraction by 120. In the case in which a user had already read information shown on 12 pay pages in the past, by referring this record to the past record evidencing the user's past usage of information providing services, it is identified that the charge for reading information on 12 pay pages corresponds to 2 points per page, and thus, the display unit 53 displays a numeric value 24, whereas a numeric value 1076 is shown on the display unit 55 via a subtraction by 20. In this case, when a user reads information shown on 12 pay pages for the first time, it is possible for him to read all the above information at ¥10 of practical charge, and yet, he can read all the above information at ¥2 of practical charge from the next time on.

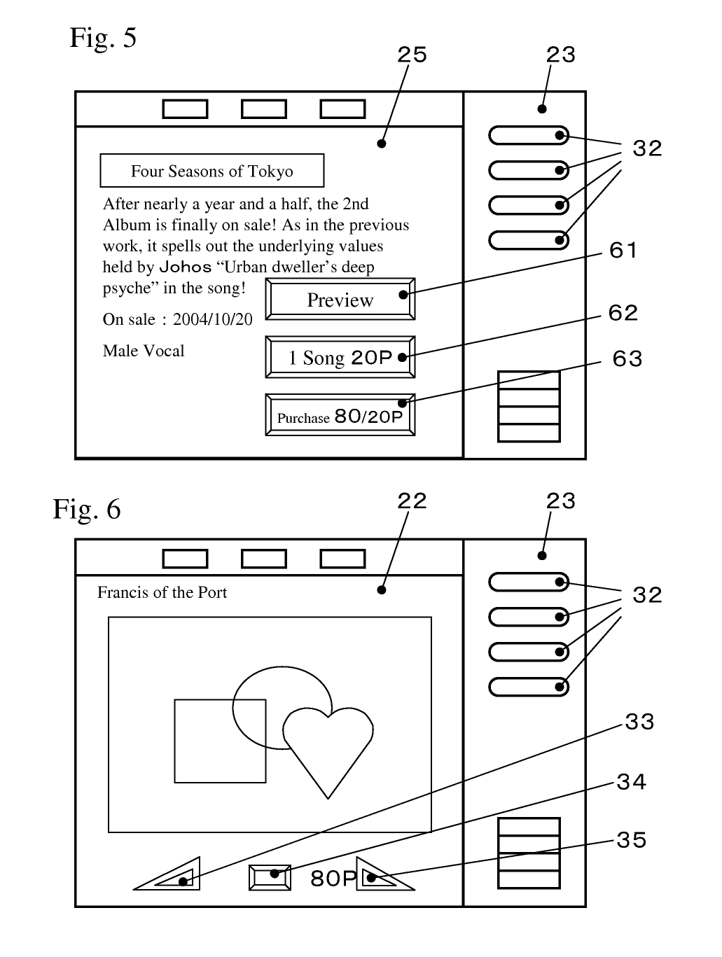

FIG. 5 illustrates an exclusive home page displayed on a terminal screen owned by a user according to an embodiment for distributing and selling a variety of information data comprising image data and music data for example. The fifth portion 25 is disposed at the center of the terminal screen owned by the above user, in which an explanatory description and an automatic transmission instructing button are displayed. Concretely, the fifth portion 25 accommodates explanatory descriptions for music tunes as an information data provided via a service line, an auditory button 61, a music distribution button 62 for enabling the user to repeatedly listen to the whole of a music tune, and a music data purchasing button 63 for enabling the user to purchase any music tune as an information data. A numeric value shown on the button 63 designates a consideration for a corresponding music data. A numeric value 20 shown on the music distribution button 62 constitutes essential points for receiving distributed music tunes. A numeric value 80 shown on the music data purchasing button 63 constitutes the number of essential points for purchasing music data and the other numeric value 20 constitutes the number of essential points for making a re-purchase of music data. When a user purchased the music data for the first time, a numeric value 80 is subtracted from the variable x correlated with the user's ID, whereas when the user re-purchased the music data, a numeric value 20 is subtracted from the variable x. In a practical form for embodying the present invention, within 24 hours from the purchased time, the variable x is not subject to subtraction against the request for automatic transmission of information data for the second time. This arrangement is made so as to cope with presumable discontinuation of data on the halfway of its transmission or potential breakage of data caused by incidental trouble on the way of transmission. Thenceforth, a numeric value 20 is subtracted from the variable x against a request for automatic transmission of any of information data. Note that the inventive system predetermines that an information provision record shall be retained for 3 consecutive years, and thus, unless any operation for automatic transmission of information is actuated within 3 consecutive years, a numeric value 80 is subtracted from the variable x when a user generates a request for automatic transmission of information next time.

FIG. 6 illustrates an embodiment of screen displayed on a terminal of a user in the course of providing an information reviewing service via video, photographs, comics, character information, or presentation material, or the like. The fifth portion 25 is disposed at the center of the terminal screen owned by a user. The fifth portion 25 accommodates an automatic transmission instructing button 35 for enabling the user to review an explanatory description of the provided information and new pages, another button 33 for returning to the preceding page, and another button 34 for suspending the reading of provided information.

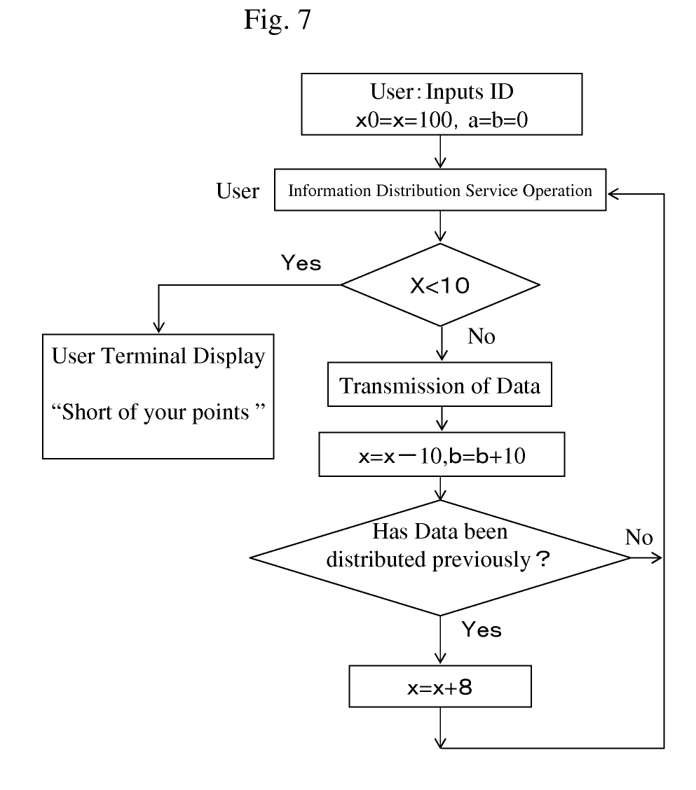

FIG. 7 is a flowchart for explanatory of the serial functions of the first discount system available for the second embodiment of the present invention. At an accessing time, a numeric value 100 is substituted for a variable x0 in a user's private home page provided with a variable x having a numeric value 100 at the preceding accessing time, whereas the numeric values of the remaining variables a and b are respectively reduced to 0. When the corresponding user operates his terminal for receiving an information providing service, the server judges if the value of the variable x exceeds 10 or not. The present embodiment rules that the predetermined value of the variable x is 0. If the numeric value of the variable x were less than 10, the server transmits a message to the terminal of the corresponding user advising that “you are short of points” and withholds automatic transmission of information to his terminal. If the numeric value of the variable x exceeds 10, the server automatically transmits information to his terminal, and simultaneously adds a numeric value 10 to the variable b and subtracts a numeric value 10 from the variable x. Next, the server refers a data number requested by the user for presentation to the record on the use of information providing service in the past stored in correlation with the ID of the corresponding user, and then, if both data were not coincident with each other, while retaining the variable x as it is, the user is enabled to resume normal operation for receiving the information providing service. If both data were found to be coincident with each other, the server identifies that re-transmission of information is practicable. In consequence, the variable x is added with a numeric value 8 to enable the user to receive the following information. After passing through these processes, the user is enabled to continuously receive the information providing service until his own points have been exhausted or arrive at a predetermined numeric value.

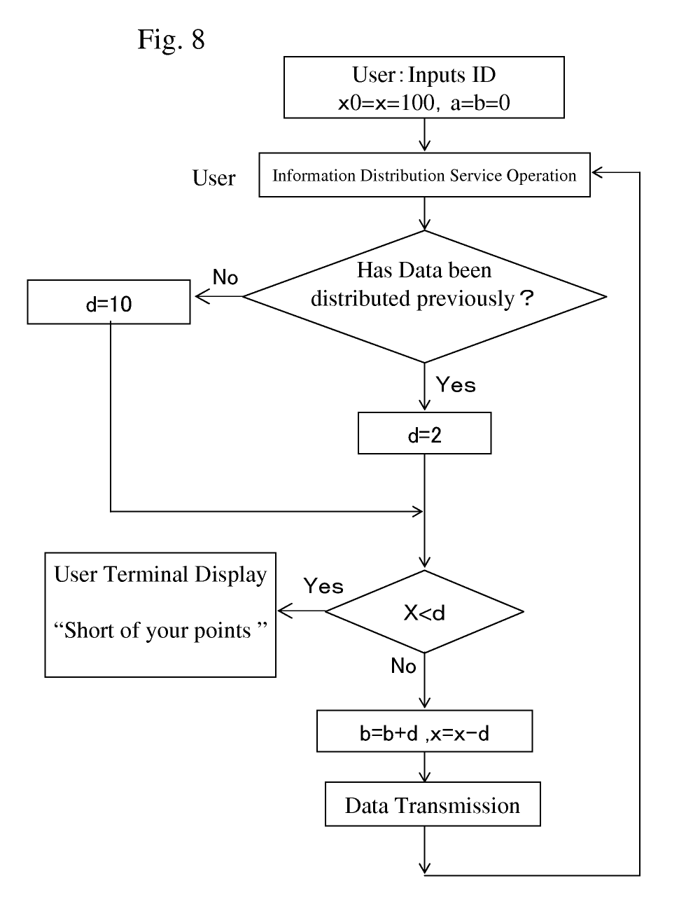

FIG. 8 is a flowchart representing serial processes of the second discount system available for the second embodiment of the present invention. A numeric value 100 is substituted for a variable x0 correlated with the ID of a corresponding user who had a numeric value 100 of the variable x at the preceding accessing time. The numeric values of the remaining variables a and b are respectively reduced to 0. When the corresponding user operates his terminal for receiving an information providing service, the server refers the ID number of the information accessed by this user to the record of the use of information providing service in the past stored in correlation with the ID of this user, and then, if both data were not coincident with each other, a numeric value 10 is substituted for the variable d, whereas if both data were coincident with each other, then, a numeric value 2 is substituted for the variable x as a charge for retransmission of information. Next, the server judges if the value of the variable x exceeds that of the variable d or not. If the value of the variable x were less than that of the variable d, any of the pay pages is not displayed, instead, a message advising that “you are short of points” is displayed on the user's terminal screen. If the value of the variable x were not less than that of the variable d, then, a value d is added to the variable b, and conversely, the value d is subtracted from the variable x to resume transmission of information thereby enabling the corresponding user to normally receive the following information providing service. After passing through the above processes, the above user is enabled to make use of information providing services until his points have been exhausted or arrive at a predetermined numeric value.

Next, practical aspects of the third embodiment of the present invention are described below. Transmissible object via the information providers includes documents, images, pictures, music, comics, useful data, and all the transmissible objects. When an information provider transmits information to any of distribution operators, the information provider simultaneously transmits a predetermined consideration value d for the corresponding information providing service to every distribution operator. Generally, any remuneration rate P against a consideration has been presented by the distribution operators in advance. However, the remuneration rate P may also be determined via individual negotiations with information providers. Although the remuneration rate P may be of a stationary value, it is also possible to determine said rate based on a function against the sales volume.

In this case, if a corresponding information provider were not well known or in the case of choosing 0 based on an intent for prevailing specific information among the public, it is also possible to publicize it free of charge.

Further, it is also possible to publicize the former half of any production free of charge and the latter half to be chargeable whichever the one depending on the discretion of any of information providers. In this case, it is also possible for any information provider to choose a concrete amount of consideration from various numeric values predetermined by distribution operators. Further, it is also possible to predetermine a maximum allowable amount. In this embodiment, upon receipt of information, a server of a distribution operator stores the received information in the state capable of automatically transmitting the received information via public lines. If the information content comprises a novel, the server prepares a list together with other novels and publicizes the novels on its home page in the state enabling users to retrieve any of the publicized novels. The list is provided with a button for instructing automatic transmission of various novels to enable users to optionally choose any of the interested novels and subscribe it by clicking this button.

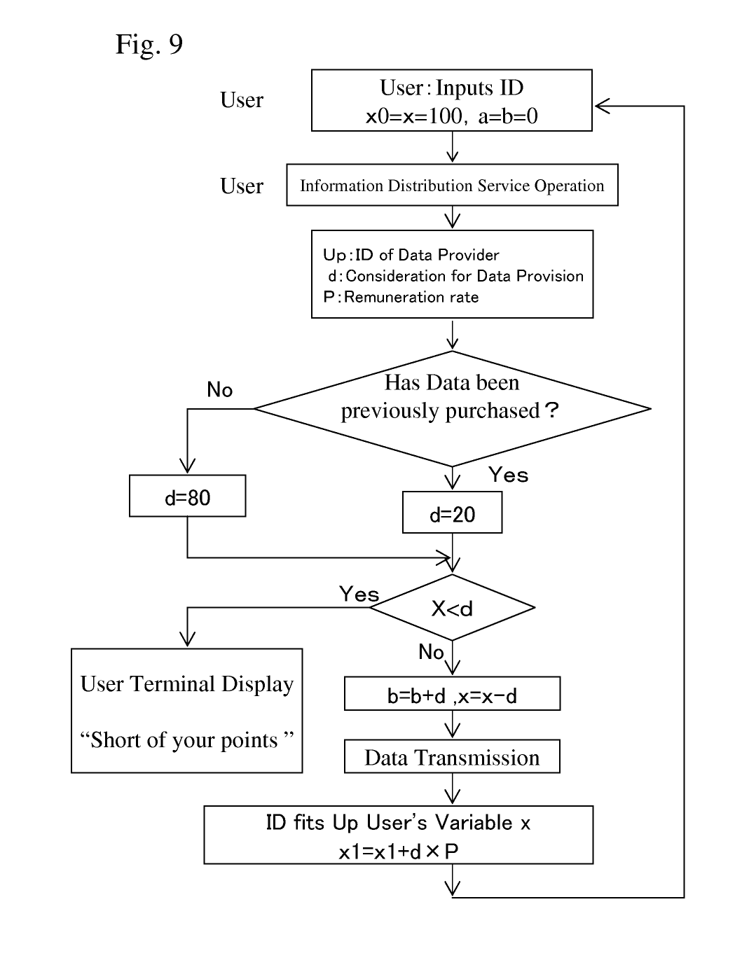

FIG. 9 is a flowchart designating serial processes of the remuneration paying system against providers of royalties reflecting the third embodiment of the present invention. When a user inputs his own ID so as to access a numeric value x correlated with his ID, and then clicks a button for instructing automatic transmission of information, in other words, by operating a button for instructing it to receive an information providing service, his terminal accesses Up being the ID of an information provider stored in the server, a consideration d for the provision of required information, and a remuneration rate P. Next, when the required information has been received via predetermined processing steps as shown in FIG. 7, a numeric value generated via multiplication of the consideration d for the information providing service by the remuneration rate P is added to a variable xl correlated with the above information provider.

Transition of numeric values is concretely described below. Assume that a consideration value against conventional users for a piece of a novel is determined to be 80 points, whereas a consideration value at the time of retransmission of a piece of a novel is determined to be 20 points. In this case, it is so contracted that royalty will be paid to an information provider concurrently with an original author of the above novel by 50% of the consideration amount for the information providing service. In this case, remuneration rate P=0.50. When a conventional user clicks a button for automatic transmission of the above information, if there were no record related to the transmission of said data in the past, a numeric value 80 is subtracted from the variable x. In consequence, a numeric value 40 resulted from a calculation 80×0.50 is added to the variable x1 owned by the above user bearing the ID expressed as Up. If the added value of the variable x1 were coincident with user's transmission record in the past, a numeric value 20 is subtracted from the variable x owned by this user. Simultaneously, a numeric value 10 resulted from a calculation 20×0.50 is added to the variable x1 of this user bearing the ID expressed as U1. After passing through the above processes, payment of a remuneration for the provision of information is hypothetically executed against an information provider. When the numeric values of the variable x1 have been accumulated to some extent, a liquidation into cash is implemented acting on the instructions of the information provider, thereby a remuneration for provision of information is actually paid to the information provider.

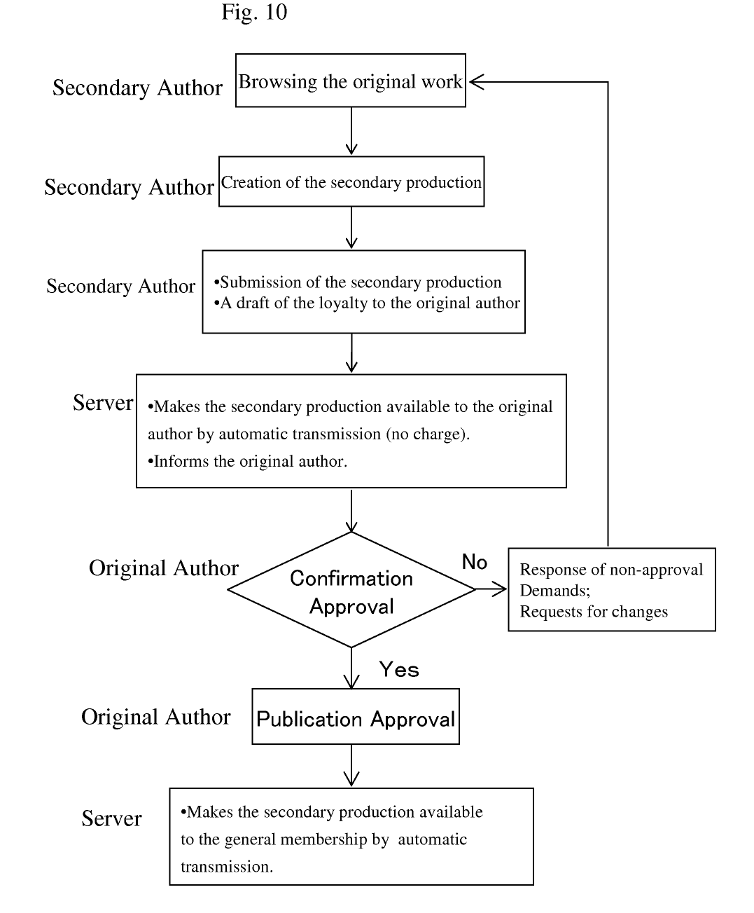

The fourth embodiment of the present invention deals with all the processes ranging from the contribution of a secondary production up to an eventual payment of a remuneration to an author at the time of publication. Referring now to a flowchart shown in FIG. 10, the above serial processes are described below. By reviewing a production shown on a home page of a distribution operator, a secondary author creates a secondary production. If the original production solely comprises a novel, the secondary author may insert figures, cartoons, or translate the contents. When the secondary author contributes a completed secondary production to a distribution operator, he submits a draft of the royalty to the original author. From the viewpoint of popularity of the original novel and notability of the original author, it is also possible for the distribution operator to present a share division rate in advance, for example, a 40% share for a translator, or the like. Except for the share division rate of the royalty, the distribution operator may disclose contents of the fundamental contract. After receiving a contribution of the corresponding production, the server records the contributed production in the style solely enabling the original author to exclusively receive the corresponding secondary production via an automatic transmission. The server further notifies the original author of the contribution of the secondary production made by a secondary author and a method for accessing and contacting the secondary author. The original author scrutinizes in detail whether or not the secondary production would deteriorate his honor, whether or not the contents of the secondary production deviate from the intent of the original author, whether or not there is any particular item that should be added to the fundamental contract, or whether or not the share division rate is appropriate, or the like.

Only after confirming the above requirements, the original author operates his terminal so as to approve publication of the completed secondary production. Simultaneously with the clicking of a button for approving publication of the second production effected by the original author as of the state accessing the server, automatic transmission of the secondary production to any of conventional users eventually becomes practicable. Simultaneously, it has become practicable to pay a remuneration to the original author and the secondary author. Conversely, if the original author disapproves the publication of the secondary production, he will notify the secondary author of the reasons, essential points requiring an improvement, and details of contents to be added to the fundamental contract, or the like, via an e-mail. Upon receipt of the notice from the original author, the secondary author strives to improve the contents of his production in anticipation of the approval to be granted by the original author, and then again makes a contribution after rearranging the contract requirements. Eventually, the original author checks and confirms the improved contents.

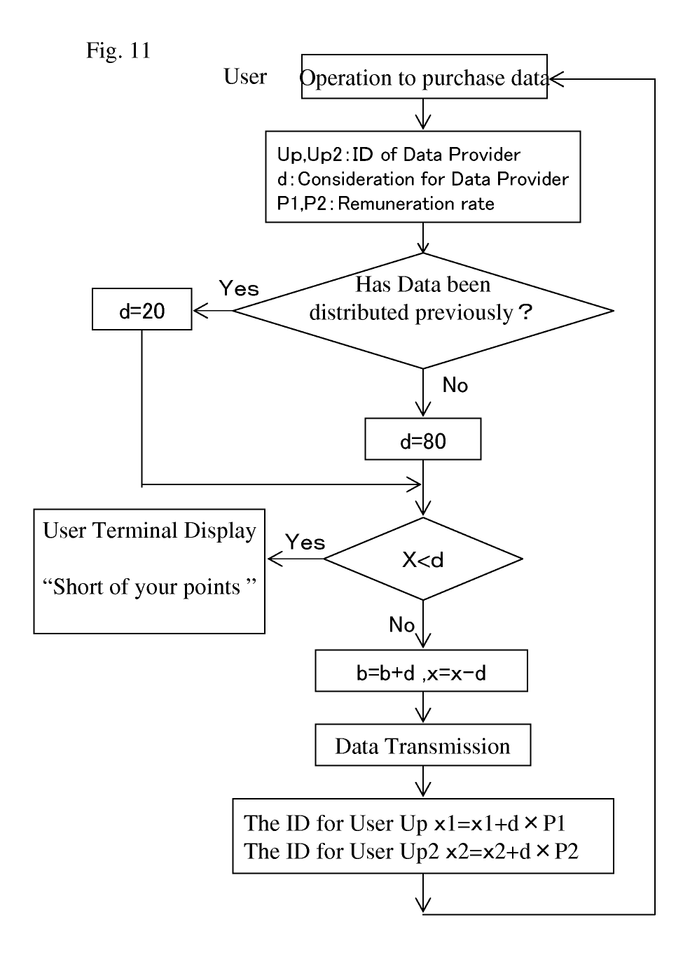

FIG. 11 is a flowchart designating serial processes of the system for paying a remuneration such as royalties when a plurality of authors including the original and secondary authors are correlated with each other as described in the fourth embodiment of the present invention. In the present case, an information provider provides music data. It is assumed that a consideration d against conventional users is rated to be 80 points, whereas the consideration at the time of retransmission is rated to be 20 points. In this case, there are two users actually providing music data. FIG. 11 represents a case in which a contract has been formed so as to cause a user ID being a lyricist concurrently with a composer to pay performance fees comprising a consideration P1 to a user U1, whereas another user ID being a performer concurrently with a singer will pay performance fees comprising a consideration P2 to a user U2. A server correlated with the operation for transmitting the above music data stores those data comprising 80, 20, U1, P1, U2, and P2.

For further details, the following description refers to a case in which authors are entitled to secure 50% share of the remuneration rate, whereas the above users U1 and U2 are discretely allocated with 60:40 of the share division rate for receiving the remuneration. In this case, the amount of consideration P1 is expressed as 0.50×0.60=0.30, whereas the amount of consideration P2 is expressed as 0.50×0.40=0.20. When any of normal users operates his terminal for making use of a service for providing music data, if there were no record of data transmission in the past, a numeric value 80 is subtracted from the variable x owned by the corresponding user. Simultaneously, a numeric value 24 resulted from a calculation 80×0.30 is added to the variable x1 of the user having own ID expressed as U1, whereas a numeric value 16 resulted from a calculation 80×0.20 is also added to the variable x2 of the user having the ID expressed as U2. If either of the above numeric values coincides with any of the past transmission records of any of conventional users, a numeric value 20 is subtracted from the variable x owned by any of them. Simultaneously, a numeric value 6 resulted from a calculation 20×0.30 is added to the variable x1 owned by a user having the ID expressed as U1, whereas a numeric value 4 resulted from a calculation 20×0.20 is also added to the variable x2 owned by a user having the ID expressed as U2. After completing the above processes, a remuneration for the provision of information is paid to plural authors.

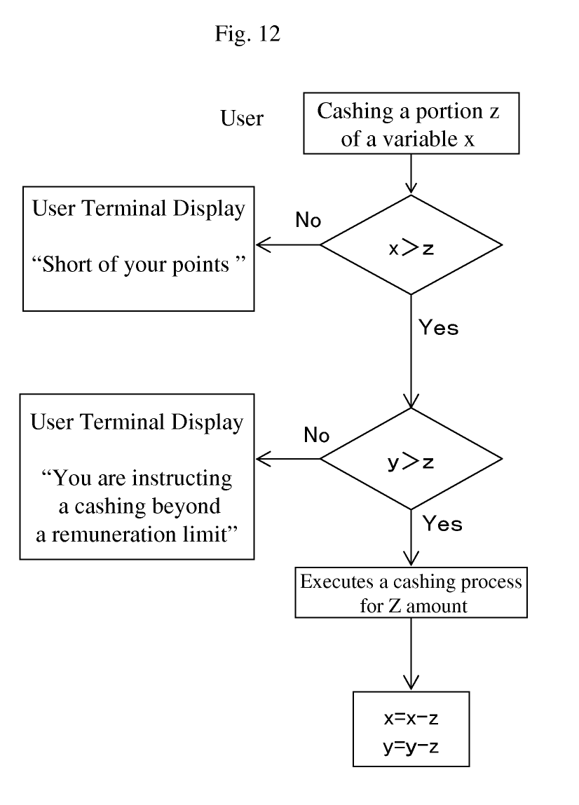

FIG. 12 is a flowchart of liquidation processes executed by a system for paying a remuneration to providers of royalties according to an embodiment of the present invention. A server stores a sum of remunerations paid to users concurrently with information providers for the provision of valuable information in the past in the form of a variable y. When instructions are output from a terminal of a corresponding user for cashing a portion z of a variable x owned by himself, the server compares the variable x to the portion z under the instructions for cashing. If the actual value of the variable x were less than that of the portion z, the server transmits a message to the user's terminal by advising that “you are short of points” and rejects the instructions for implementing a cashing process. Even when the actual value of variable x exceeds the other one, the server compares an actual value of an ensuing variable y to the actual value of the portion z, and then, if the actual value of the variable x were not greater than that of the portion z, the server transmits a message to the user's terminal advising that “you are instructing a cashing beyond a remuneration limit” and rejects the instructions for implementing a cashing process. If the actual value of the variable y exceeds that of the variable x, the server executes a cashing process for a sum corresponding to the actual value of the portion z. By serially executing the above processes, the server is enabled to discern and cope with instructions for illegally implementing a cashing process.

### INDUSTRIAL APPLICABILITY

By replacing conventional methods for marketing printed newspapers, printed books, printed comics, music data stored in compact discs, DVDs, and magnetic tapes, provision of various information via internet services has been prevailing more extensively today. It is anticipated that any of conventional classes, courses, and lectures will be provided by information reviewing services via internet lines from now on. The present invention provides a useful convenience for a charge assessing system available for information providing services requiring a consideration via internet service, and thus, the inventive charging system provides a great advantage for furthering development of information providing services.

The present invention has enabled a charging system available for an internet service to be applied to a remuneration paying system. Since any of information providers can be benefited by a convenience for receiving a remuneration, the inventive remuneration paying system provides further effect for increasing the volume of information provided for information industries.

Further, the present invention facilitates an easier contact between the original author and a secondary author for publishing a secondary work and also facilitates publication of said secondary work and subsequent payment of a remuneration in conformity with a share rate for royalties. For the sake of expediting the time of publicizing a secondary work, the inventive system for paying the remuneration executes an important function by stimulating creative intent of literary figures for creating a secondary work, and further contributes to the development of economy by enabling the volume of secondary works to be increased and enhancing the product value. For example, it is understood that any of the secondary works could become a useful means for promoting publishing business activities via its multilingual translations. This is because, despite a desire for publicizing any production via translation, due to difficulty to properly arrange the use of copyrights against original authors and assignees of copyrights in foreign countries, any domestic literary figure has so far been prohibited from publication of translated works unless securing approval of foreign writers reserving the original copyrights, and so, any domestic writer has so far been approved for merely publicizing limited translated works restrictively by following precedents or the one anticipated to gain potentially large profits.

The present invention makes it possible to simplify the negotiation process against them by applying an internet service without spending much time. In consequence, it has become possible to minimize a potential risk of losing an appropriate opportunity for translating a valuable work via lowered value of a corresponding foreign production after spending a lot of time to properly arrange the use of copyrights. This will in turn contribute to a growth of the publication of secondary productions, thus advantageously affecting the information industries. Unlike any conventional publishing work, the inventive system fundamentally adopts automatic transmission of data via an internet service that dispenses with a printing process, even when insubstantial profits are estimated, the inventive system still enables any of literary figures to publicize translated works, and accordingly, the present invention effectively contributes to the expansion of opportunities for publishing secondary productions such as translated works, thereby further contributing to the development of information industries.

1-5. (canceled)

6. A method of assessing charges and paying a reward to information providing services by an automatic public transmission line; wherein said method provides information providing services by a server that is connectable to individual user terminals by automatic public transmission lines; wherein said server is equipped with the following;
a means which, upon reception of a user's ID and password from a terminal of said user, enables to access a first variable (hereinafter referred to as “x”) stored in said server correlated with said user's ID corresponding to a numerical value representing preserved points that reflect a sum paid by said user stored in said server, and then transmits said first variable “x” to said user's terminal for displaying said variable on said user's terminal;
a means which, upon designation of information, enables transmission of an automatic information transmission instruction operating signal from said user's terminal;
a means which enables to store information received from said user's terminal (hereinafter referred to the user who transmitted said information as the information providing user) in the state transmissible by an automatic public transmission line;
a means which, in correlation with said information, enables to store the ID of said information providing user (including the case comprising plural users), a consideration for said information, and a pay rate applied to said information providing user; and
a means which enables to store a second variable (hereinafter referred to as “y”) correlated with the ID of said information providing user;
wherein the above server is further equipped with the following a means which enables to execute the following processes upon reception of an automatic information transmission instruction operating signal from a user's terminal;
a step of automatically transmitting the information instructed by said server;
a step of decreasing (or increasing) the first variable “x” correlated with a user's ID based on a request for presentation of information by a numerical value corresponding to the consideration payable for said information; and
a step of assessing charges and paying virtual reward by adding (or subtracting) numerical values resulted from a multiplication of said consideration payable to said information by said pay rate to (or from) said variables “x” and “y” which are respectively stored in said server and correlated with the ID of said information providing user related to said information;
a means which enables to generate instructions to execute a cashing process by the terminal of said information providing user by specifying a numerical value applicable to a cashing process;
a means which enables to make a comparison between a cashing instruction numerical value (hereinafter referred to as “z”) and the first and second variables “x” and “y”;
wherein, when the above information providing user generates instructions to execute a cashing process, if the numerical value “z” were less (or more) than the first variable “x” and the second variable “y”, said method executes a cashing process by an arithmetic operation by way of subtracting the cashing instruction numerical value “z” from the above variables “x” and “y” or adding said value “z” to said variables “x” and “y”, wherein, if said value “z” were in excess of (or less than) “x” or “y”, said method executes a judging operation so as to discontinue said cashing process correlated with a payment of reward.

7. A method of providing information providing services related to secondary works and a method of assessing charges and paying reward to information providing services related to secondary works by automatic public transmission lines by way of executing a method set forth in claim 6; wherein said method provides information providing services by a server that is connectable to individual user terminals by automatic public transmission lines; wherein said server is equipped with the following:
a means for storing contacting destinations in correlation with the ID of information providing users;
a means which, based on an information automatically transmitted from said server, enables another information providing user to transmit a new information to said server in correlation with an original work by a terminal of a secondary author; (Note: The above-referred new information is hereinafter referred to as a secondary work, the user providing the new information as a secondary author, the original information as an original work, and the user providing information of the original work as an original author.) a means which enables to store the received secondary work in the transmissible condition by automatic public transmission lines;
a means which enables to store the consideration for the corresponding information correlated with the above information, individual IDs of an original author identified as the information providing user and the above secondary author, and the pay rate applicable to individual information providing users; and
a means which enables the terminal of said original author to transmit a publication approval operating signal;
wherein, when said server has received the above secondary work, said server executes the following stepwise processes;
a step of storing said secondary work so that it can be transmitted automatically;
a step of storing the ID of said secondary author and the ID of the original author (the ID of the information providing user against the original work) as the ID of the corresponding information providing user;
a step of solely enabling the original author to automatically transmit the corresponding secondary work;
a step of enabling said server to automatically contact the previously stored contacting destination of the original author so as to notify him of the effect that the secondary work has been contributed; and
a step of enabling said server to automatically transmit said secondary work to users at large for the first time only when signal for approving the disclosure of the corresponding secondary work has been received from the terminal of the corresponding original author.

8. A charge-assessing and reward-paying system available for information providing services by applying automatic transmission of information by automatic public transmission lines; wherein, in a system consisting of a server and individual user's terminals connectable to said server by said automatic public transmission lines, said server is equipped with the following:
a means which enables to store the ID of a corresponding user, a password correlated with said ID, and a variable “x” corresponding to a numeric value representing preserved points reflecting a sum paid by the corresponding user;
a means which, upon reception of said ID and password from a user's terminal, transmits a numerical value of said variable “x” stored in correlation with said ID for displaying it on the terminal screen of said user;
a means which enables to designate an information by the user's terminal and then enables an automatic information transmission instruction operating signal to be transmissible;
a means which, when an information has been received from a terminal of the corresponding information providing user, enables to store said information correlated with the ID of said information providing user in the transmissible condition by automatic public transmission lines;
a means which enables to store the ID of the corresponding information providing user in correlation with the information received by the terminal of said information providing user, the consideration for the corresponding information, and the pay rate applied to said information providing user;
a means which enables to store a variable “y” correlated with the ID of said information providing user;
a charge-assessing means which, when automatically transmitting a designated information to the terminal of a corresponding user upon reception of an automatic transmission instruction operating signal against an information from said user's terminal, enables to execute an arithmetic operation by way of decreasing (or increasing) a numerical value of a variable “x” correlated with the ID of said user by a numerical value corresponding to the consideration previously stored in correlation with said information; and
a virtual reward paying means which, simultaneously with automatic transmission of an information from an information providing user stored in a corresponding server, enables to execute an arithmetic operation by way of increasing (or decreasing) variables x” and “y” stored in correlation with ID of said information providing user stored in association with a corresponding information by a numerical value resulted from a multiplication of a numerical value of the consideration stored in correlation with a corresponding information by a pay rate applied to the consideration of said information;
wherein, said server is further equipped with the following:
a means which enables to generate cashing instructions by specifying a cashing numerical value by the terminal of a corresponding information providing user;
a means which enables to make a comparison between the cashing instruction numerical value “z” and the variables “x” and “y”; and
a means which, upon generation of cashing instructions by the corresponding information providing user, if the cashing instruction numerical value “z” were less than (or more than) the variables “x” and “y”, enables to execute an arithmetic operation by way of subtracting the numerical value “z” from the variables “x” and “y” to complete a cashing process, whereas if the cashing numerical value “z” were in excess of the variables “x” or “y”, enables to discontinue the cashing process.

9. A charge-assessing and reward-paying system against information providing services by automatic public transmission lines in presence of a plurality of authors as set forth in claim 8, wherein said server is further equipped with the following:
a means which, in correlation with an information stored in the automatically transmissible condition in presence of a plurality of information providing users, enables to store numerical values of the consideration (d) for the corresponding information, the IDs (Ui) of individual information providing users, and the pay rate (Pi) applied to individual information providing users; and
a virtual reward paying means which, when an automatic transmission instruction operating signal against a corresponding information has been received from a user's terminal, enables to execute an arithmetic operation by way of increasing (or decreasing) “xi” and “yi” stored in correlation with the IDs (Ui) of a plurality of information providing users previously stored in correlation with said information by numerical values (d×Pi) resulted from a multiplication of numerical values of individual considerations stored in correlation with said information by a pay rate applied to individual considerations against the corresponding information.

10. An information providing system by automatic public transmission of secondary works, wherein said system corresponds to a charge-assessing and reward-paying system for information providing services by automatic public transmission against information in which a plurality of authors are present as set forth in claim 9, wherein said server is further equipped with the following:
a means which enables a terminal of a secondary author to transmit a secondary work in correlation with an original work;
a means which enables to store contacting destinations in correlation with the IDs of information providing users;
a means which enables the terminal of an original author to transmit a publication approval operating signal;
a means which, when a secondary work has been received, enables to store the ID of the corresponding secondary author and the ID of the original author (i.e. the ID of the information providing user against the original work) as the ID (Ui) of the corresponding information providing user;
a means which, only when a secondary work has been received, solely enables the original author to automatically transmit the corresponding secondary work when storing said secondary work in the automatically transmissible condition;
a means which, when a secondary work has been received, enables a corresponding server to automatically contact the contacting destination of the original author stored in memory so as to inform him of the effect that the corresponding second work has been contributed; and
a means which, when a signal for approving disclosure of the above secondary work has been received from the terminal of the original author, enables automatic transmission of the corresponding secondary work to users at large for the first time.
